(19) United States
(12) Patent Application Publication
(10) Pub. No.: US 2026/0163037 A1
(43) Pub. Date: Jun. 11, 2026

(54) Fuel Cell System With Modular Power Electronics Modules

(71) Applicant: GM GLOBAL TECHNOLOGY OPERATIONS LLC., Detroit, MI (US)

(72) Inventors: Brian PODCZERVINSKI, West Bloomfield, MI (US); Yan ZHANG, Oakland Township, MI (US); Marcus Vinicius AMARAL, Lake Orion, MI (US)

(21) Appl. No.: 18/969,374

(22) Filed: Dec. 5, 2024

(51) Int. Cl. H01M 8/04858; B60L 58/30; H01M 8/04111; H01M 8/04746

(52) U.S. Cl. CPC H01M 8/0494; B60L 58/30; H01M 8/04111; H01M 8/04753; H01M 2250/10; H01M 2250/20

(57) ABSTRACT

A fuel cell module is disclosed and includes: a fuel cell stack comprising a first one or more exterior interfaces; and modular power electronics modules (MPEMs), where each of the MPEMs includes at least one sub-system module configured to perform operations with respect to the fuel cell stack, and a respective one or more exterior interfaces each of which standardized and configured to couple to each of the first one or more exterior interfaces. The one or more exterior interfaces of one of the MPEMs is configured to couple to the other exterior interfaces of the other ones of the MPEMs.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to fuel cells.

A fuel cell receives fuel including hydrogen and oxygen and splits the hydrogen into protons and electrons via an anode. The protons pass through an electrolyte membrane to reach a cathode where the protons are combined with the oxygen atoms and electrons to produce water and electricity. The electricity may be used, as an example, for propulsion purposes when the fuel cell is implemented in a vehicle. As another example, a fuel cell may be used as a generator to power various loads.

### SUMMARY

A fuel cell module is disclosed and includes: a fuel cell stack comprising a first one or more exterior interfaces; and modular power electronics modules (MPEMs), where each of the MPEMs includes at least one sub-system module configured to perform operations with respect to the fuel cell stack, and a respective one or more exterior interfaces each of which standardized and configured to couple to each of the first one or more exterior interfaces. The one or more exterior interfaces of one of the MPEMs is configured to couple to the other exterior interfaces of the other ones of the MPEMs.

In other features, each of the first one or more exterior interfaces and the one or more exterior interfaces of the MPEMs includes communication bus terminals and power terminals.

In other features, each of the first one or more exterior interfaces and the one or more exterior interfaces of the MPEMs includes cooling channels.

In other features, the power terminals include low voltage terminals having voltages less than or equal to 48V and high voltage terminals having voltages greater than or equal to 50V.

In other features, each of the MPEMs includes sub-system modules including the at least one sub-system module of the corresponding one of the MPEMs. Each of the sub-system modules includes at least one interior interface standardized to couple to each other one of the interior interfaces of the sub-system modules of the corresponding one of the MPEMs.

In other features, the MPEMs include: a first MPEM implemented as a power conversion module (PCM); and a second MPEM implemented as a power distribution control and safety module (PDCSM).

In other features, the PCM includes at least one of a power conversion module, a sensing module, a high frequency resistance sensing module, and a filtering module.

In other features, the PDCSM includes at least one of a stack sensing module, a high frequency resistance sensing module, a filtering module, an application sensing module, a fuse module, a pyrotechnic module, a contactor module; and an inverter module.

In other features, the PDCSM includes an electrical domain control module for controlling operation of the sub-system modules of the PDCSM and the fuel cell stack.

In other features, the electrical domain control module controls operation of at least one of the PCM and a fluidic domain control module.

In other features, at least one of the MPEMs includes buses and bus bars including communication buses and power bus bars that extend between exterior interfaces of the at least one of the MPEMs.

In other features, one of the MPEMs is implemented as a fluidic domain control module and includes hardware drivers, fuses, and a master local interconnect network.

In other features, the one or more exterior interfaces of one of the MPEMs couples to an electric air compressor of the fuel cell module that is driven by an inverter.

In other features, the one of the MPEMs includes: high voltage balance of plant interfaces configured to connect to pumps; one or more access panels for accessing the at least one sub-system module of the one of the MPEMs; a low voltage data and power output interface configured to couple to a load; and a high voltage output interface configured to couple to the load.

In other features, the MPEMs are configured to be coupled to each other and the fuel cell stack in different arrangements.

In other features, the different arrangements include: a stacked arrangement where a first MPEM is coupled between a second MPEM and the fuel cell stack where the MPEMs include the first MPEM and the second MPEM; a centralized arrangement where the first MPEM and the second MPEM are both coupled to the fuel cell stack; and a combination arrangement where two or more of the MPEMs are coupled to the fuel cell stack and one or more other ones of the MPEMs are not coupled to the fuel cell stack but rather are coupled to one of the MPEMs.

In other features, the MPEMs are integrated with non-repeating hardware of the fuel cell stack.

In other features, the non-repeating hardware includes at least one of: one or more housings; fuel cell ends; and compression hardware.

In other features, a vehicle is disclosed and includes: one or more of the fuel cell module configured to generate electrical energy and including an electrical domain control module; and a vehicle control module configured to communicate with the electrical domain control module to control operation of the fuel cell stack and control distribution of the electrical energy to devices of the vehicle.

In other features, a stationary power station is disclosed and includes: one or more of the fuel cell module configured to generate electrical energy and including an electrical domain control module; and a main control module configured to communicate with the electrical domain control module to control operation of the fuel cell stack and control distribution of the electrical energy to loads connected to the stationary power station.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a vehicle including an example fuel cell system in accordance with the present disclosure;

FIG. 2 is a functional block diagram of a stationary power station including an example fuel cell system in accordance with the present disclosure;

FIG. 3 is a functional block diagram of an example control system for multiple fuel cell modules (FCMs) in accordance with the present disclosure;

FIG. 4 is a functional signal and fluid flow diagram of an example fuel cell system in accordance with the present disclosure;

FIG. 5 is a schematic and functional block diagram of a portion of an example fuel cell system illustrating various different sensors in accordance with the present disclosure;

FIG. 6 is a schematic and functional block diagram of an example FCM in accordance with the present disclosure;

FIG. 7 is a functional block diagram of a first example modular power electronics module (MPEM) (also referred to as a power distribution control and safety module) in accordance with the present disclosure;

FIG. 8 is a functional block diagram of a second example MPEM (or power conversion module) in accordance with the present disclosure;

FIG. 9 is a functional block diagram of a third example MPEM (or fluidic domain control module) in accordance with the present disclosure;

FIG. 10 a functional block diagram of another example MPEM, which may represent each of the MPEMs of FIGS. 7-9, illustrating interior and exterior interfaces relative to sub-system modules in accordance with the present disclosure;

FIG. 11 is a front view of an example exterior interface in accordance with the present disclosure;

FIG. 12 is a front view of an example interior interface in accordance with the present disclosure;

FIG. 13 is an example sub-system module with a passthrough cooling circuit providing internal and/or passthrough cooling in accordance with the present disclosure;

FIG. 14 is an example sub-system module with non-passthrough cooling circuit in accordance with the present disclosure;

FIG. 15 is an example sub-system module with a low voltage electrical passthrough circuit in accordance with the present disclosure;

FIG. 16 is an example sub-system module with a low voltage electrical non-passthrough circuit in accordance with the present disclosure;

FIG. 17 is an example sub-system module with a high voltage electrical passthrough circuit in accordance with the present disclosure;

FIG. 18 is an example sub-system module with a high voltage electrical non-passthrough circuit in accordance with the present disclosure;

FIG. 19 is a layered representation of a FCM of FIG. 6 in accordance with the present disclosure;

FIG. 20 is a functional block diagram of an example portion of a FCM in a first arrangement in accordance with the present disclosure;

FIG. 21 is a functional block diagram of an example portion of a FCM in a second arrangement in accordance with the present disclosure;

FIG. 22 a perspective view of a portion of a FCM in a third arrangement in accordance with the present disclosure;

FIG. 23 a perspective view of an example portion of a FCM in a fourth arrangement in accordance with the present disclosure;

FIG. 24 is a cross-sectional view of an example portion of a FCM having an arrangement similar to that of FIG. 22 with access panels in accordance with the present disclosure;

FIG. 25 is a functional block diagram of an example sub-system module in accordance with the present disclosure;

FIG. 26 is a functional block diagram of another example sub-system module in accordance with the present disclosure;

FIG. 27 is a top view of an example sub-system module (or layer) in accordance with the present disclosure;

FIG. 28 is a top view of an example sub-system module (or layer) in accordance with the present disclosure;

FIG. 29 is a top view of the sub-system module of FIG. 28 stacked on the sub-system module of FIG. 27 in accordance with the present disclosure;

FIG. 30 is a perspective representative view of power bricks of a power conversion module in accordance with the present disclosure;

FIG. 31 is an end view illustrating high voltage terminals and parallel connections of the power bricks of FIG. 30 in a first arrangement in accordance with the present disclosure;

FIG. 32 is an end view illustrating high voltage terminals of the power bricks of FIG. 30 in a second arrangement in accordance with the present disclosure;

FIG. 33 is a cross-sectional view through one of the power bricks of FIG. 30 taken at section plane A-A in accordance with the present disclosure;

FIG. 34 is a cross-sectional view through one of the power bricks of FIG. 30 taken at section plane B-B in accordance with the present disclosure;

FIG. 35 is a cross-sectional view through one of the power bricks of FIG. 30 taken at section plane C-C in accordance with the present disclosure; and

FIG. 36 is a cross-sectional view through one of the power bricks of FIG. 30 taken at section plane D-D in accordance with the present disclosure.

In the drawings, reference numbers may be reused to identify similar and/or identical elements.

### DETAILED DESCRIPTION

A fuel cell drivetrain (or system) can include a fuel cell stack, heaters and/or pumps (e.g., a hydrogen pump and a high voltage coolant (HVC) pump), an air compressor, valves, converters, one or more heaters, a water separator, a humidifier, a recirculation fan, coolant lines (or conduits), low voltage and high voltage power lines, etc. The stated items of a fuel cell system are designed, configured, connected up, and arranged for a particular application. Fuel cell systems may be implemented in vehicular and non-vehicular applications, such as for stationary power applications. The fuel cell systems disclosed herein may be implemented in, for example, road vehicles, off road vehicles, locomotives, large and small marine applications, aircraft, stationary power applications, etc. Road vehicles include commercial and consumer vehicles, medium trucks, heavy duty trucks (e.g., class 8 trucks), passenger vehicles, etc. Heavy offroad vehicles include mining equipment trucks and vehicles, digging and earth moving equipment, transport equipment, construction machines (e.g., cranes, cement mixers, etc.), rolling platforms, etc. Locomotive applications include auxiliary power devices and traction power devices. Marine applications include auxiliary power applications and motive power applications. Aircraft applications include aircraft propulsion, aircraft auxiliary power units, drones, unmanned vehicles, etc. Stationary power applications include installed backup generators at commercial sites and other generators and charging stations (e.g., generators and charging stations implemented on trailers). Each of the modular fuel cell systems disclosed herein may be configured and reconfigured to be implemented in any of these applications.

It can be difficult to make a change to one of the items and/or parts (e.g., the fuel cell stack) without needing to change specifications, bolt patterns, components, coupling arrangements, etc. of other items and/or parts of the fuel systems. As an example, some of the hardware of a fuel cell system is designed to mechanically, electrically, and fludically connect up to a fuel cell stack and is sized and arranged to fit within a dedicated space having spatial limits for a given application. If, for example, there is a need to increase the output and thus the size of the fuel cell stack. This change can result in a need to have many other components of the fuel cell system redesigned in order for the components to connect to the new fuel cell stack and to accommodate specification requirements of a current application or requirements of a different application. As an example, the voltage, current and/or power requirements of the fuel cell stack may be increased such that size and/or quantities of plates of the fuel cell stack are increased. As a result, the specifications, sizes, coupling arrangements, etc. of other items also then need to be changed. This can require time consuming and expensive redesigning, retooling, and remanufacturing of various items. Thus, there can be numerous different fuel cell systems and corresponding componentry for the various fuel cell applications.

The examples set forth herein include fuel cell systems that include modular power electronics modules that are configured for various different applications having various different voltage, current, and power requirements, and to be connected up in various different arrangements. The examples are flexible for different fuel cell systems with different fuel cell stacks having different specifications including different sizes, shapes, voltage requirements, current requirements, power requirements, and cooling requirements.

The examples provide a high-power density fuel cell electrical architecture designed to provide modular flexibility for fuel cell system controls, safety, stack sensing, and power conversion. The architecture allows for integration and exchange of components, including stack sensing elements, power conversion modules, safety systems, and power distribution hardware, without requiring significant modifications to the major fuel cell system design.

The examples provide a scalable and adaptable platform that enables integration flexibility based on specific requirements of an application. The requirements can involve power conversion, control options, or safety features. Disclosed system modularity enhances ease of maintenance, scalability for different power levels, and optimization of fuel cell performance across various use cases, including vehicular applications, energy storage, and grid export. The adaptable platform is flexible, customizable and suitable for a wide range of fuel cell applications while maintaining high power density and safety.

The disclosed fuel cell electrical architecture has a modular design and allows for modular component integration. For example, the stated modular design allows for easy swapping and/or upgrading of components (e.g., stack sensing components, power conversion modules, safety hardware, etc.) without requiring major redesigns or adjustments to a core fuel cell stack.

The examples include one or more control modules (e.g., an electrical domain control module, a vehicle control module, a main control module, etc.) that are dynamically configurable and serve multiple functions, such as acting as a primary domain controller, a data aggregator, or a general fuel cell controller. This allows the control system to be tailored to specific application needs, whether the control modules are operating independently, for a vehicle application, and/or part of a larger multi-fuel cell configuration.

The examples provide multi-channel communication support including supporting a range of communication protocols such as variants of local interconnect network (LIN), controller area network (CAN), serial network (SENT), & Ethernet communication protocols, which enables integration with various systems. The examples further provide reconfigurable power conversion. The power conversion modules within the architecture are modular and can be reconfigured based on the specific application requirements for either an isolated or non-isolated topology. This reconfigurability allows the system to balance key design trade-offs such as trade-offs between: isolated conversion that provides galvanic isolation, which is desired for safety in high-voltage systems but generally comes with higher cost and lower efficiency; and non-isolated conversion that offers higher efficiency and lower cost, making it desirable for applications where safety isolation is not critical. The stated modularity enables system designers to select the appropriate power conversion strategy without redesigning an entire system, improving flexibility for applications such as energy storage, grid export, or direct DC power usage.

The examples further provide integrated safety systems. The modular architecture incorporates a variety of safety features, such as pyrotechnic disconnects, active/passive discharge hardware, and isolation sensing systems. These are implemented in a modular and reconfigurable manner, providing the ability to flag unsafe conditions and safely disconnect a fuel cell stack from a high-voltage bus without affecting the overall system.

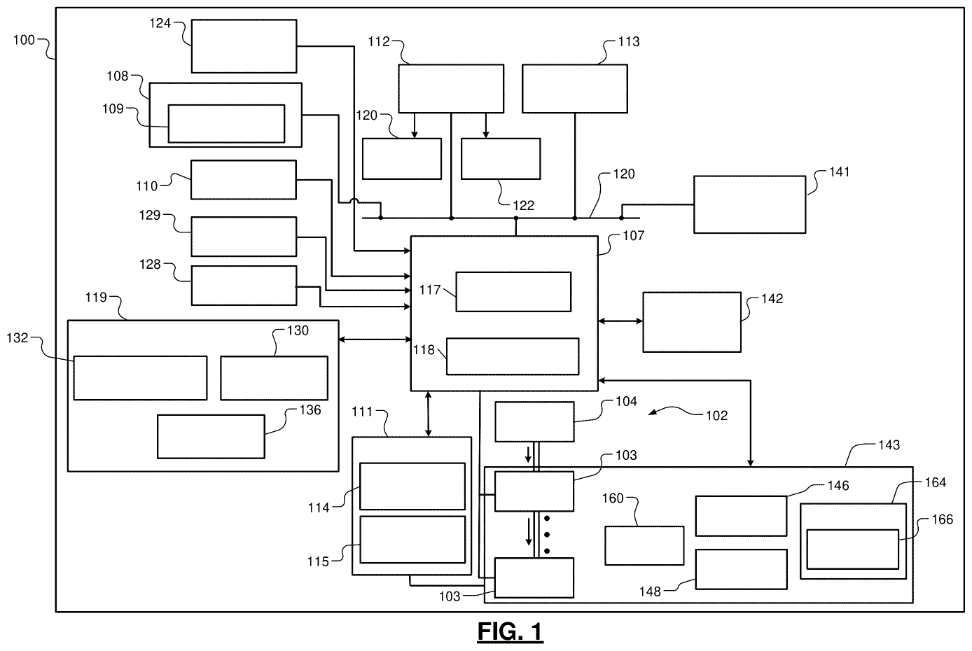

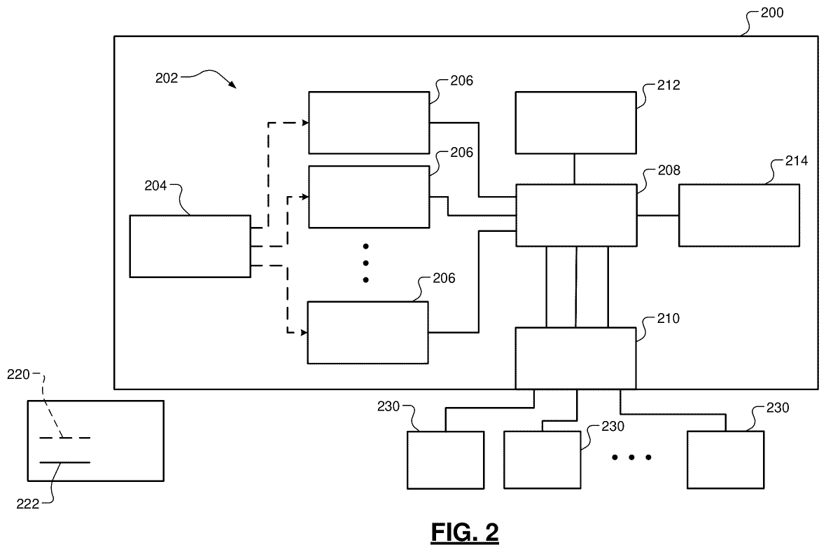

FIG. 1 shows a host vehicle 100 including an example fuel cell system 102. The fuel cell system 102 includes one or more FCMs 103, fuel sources 104, and a vehicle control module 107. The vehicle control module 107 may simply provide power requirements to the FCMs 103 or in one embodiment communicate with and control operations of the FCMs 103. Each of the FCMs may include one or more control modules, as further described below. The control modules of the FCMs may be dedicated for controlling operations of the FCMs or the vehicle control module may control operations of the FCMs or a combination thereof. The fuel sources may include hydrogen, oxygen, and/or air sources. The fuel sources may include tanks and pumps. Examples of the FCMs 103 and portions thereof are shown and described in FIGS. 2-36.

The host vehicle 100 may be a non-autonomous, partially autonomous, or fully autonomous vehicle. The host vehicle 100 may be an electric vehicle. The vehicle control module 107 controls operation of the host vehicle 100; a vision sensing (or perception) system 108 including object detection sensors 109; other sensors 110 (e.g., temperature and pressure sensors, component and actuator sensors, acceleration and velocity sensors, occupant sensors, etc.); energy source(s) 111; an infotainment module 112; and other control modules 113. The energy sources 111 includes one or more battery packs (one battery pack 114 is shown) and a control circuit 115. The battery packs may be recharged via the FCMs 103. The object detection sensors 109 may include cameras, radar sensors, lidar sensors, etc. The other sensors 110 may include temperature sensors, accelerometers, a gyroscope, a steering angle sensor, wheel speed sensors, a vehicle velocity sensor, and/or other sensors, some of which are stated above. The energy sources 111 may include low-voltage energy sources (e.g., 5V, 12V, or 48V energy sources) and high-voltage energy sources (e.g., 240-800V energy sources) for powering low-voltage and high-voltage loads. Energy is stored and then converted to useful work for low voltage and high voltage loads, motive power, auxiliary load(s), etc. The vehicle control module 107 may include a mode selection module 117 and a parameter adjustment module 118.

The modules 107, 112, 113, 117, 118 may communicate with each other and have access to the memory 119 via one or more buses and/or network interfaces 120. The network interfaces 120 may include a CAN bus, a LIN bus, an Ethernet network interface, an auto network communication protocol bus, and/or other network bus.

The vehicle control module 107 controls operations of vehicle systems. The mode selection module 117 may select a vehicle operating mode. The parameter adjustment module 118 may be used to adjust, obtain and/or determine parameters of the host vehicle 100 based on, for example, signals from the sensors 109, 110 and/or other devices and modules referred to herein.

The host vehicle 100 may further include the display 120, an audio system 122, and one or more transceivers 124. The display 120 and/or audio system 122 may be implemented along with the infotainment module 112 as part of an infotainment system.

The host vehicle 100 may further include a global positioning system (GPS) receiver 128 and a MAP module 129. The GPS receiver 128 may provide vehicle velocity and/or direction (or heading) of the vehicle and/or global clock timing information. The GPS receiver 128 may also provide vehicle location information including lane information. The MAP module 129 provides map information. The map information may include traffic control objects, routes being traveled, and/or routes to be traveled between starting locations (or origins) and destinations. The vision sensing system 108, the GPS receiver 128 and/or the MAP module 129 may be used to determine location of objects and position of the host vehicle 100 relative to the objects. This information may also be used to determine i) heading information of the host vehicle 100 and/or the objects, and ii) a relative speed of the host vehicle 100 relative to the objects.

The memory 119 may store sensor data 130, vehicle parameters 132, and applications 136. The applications 136 may include applications executed by the modules 107, 112, 113. Although the memory 119 and the vehicle control module 107 are shown as separate devices, the memory 119 and the vehicle control module 107 may be implemented as a single device. The memory 119 may be accessible to a brake control system 141 and/or a steering system 142.

The vehicle control module 107 may control operation of the systems 141, 142 and a propulsion system 143 that may include a converter/generator 146, a transmission 148, and/or electric motors 160. This control may be based on parameters set by the modules 107, 112, 113, 117, 118. The vehicle control module 107 may set some of the vehicle parameters 132 based on signals received from the sensors 109, 110. The vehicle control module 107 may receive power from the energy sources 111, which may be provided to the brake control system 141, the converter/generator 146, the transmission 148, the electric motors 160, etc. Some of the vehicle control operations may include starting and running the electric motors 160, powering any of the systems 102, 141, 142, 143, and/or performing other operations as are further described herein.

The systems 141, 142, the converter/generator 146, the transmission 148, the brake actuator system 158, and/or the electric motors 160 may include actuators controlled by the vehicle control module 107 to, for example, adjust air flow, fuel flow, steering wheel angle, speed, acceleration, braking force, etc. This control may be based on the outputs of the sensors 109, 110, the GPS receiver 128, the MAP module 129 and the above-stated data and information stored in the memory 119. The vehicle control module 107 may determine various vehicle parameters including voltages, current levels, a vehicle speed, motor speed, motor torque, yaw angle, yaw rate, a gear state, an accelerometer position, a brake pedal position, an amount of regenerative (charge) power, understeer coefficient and/or value, oversteer coefficient and/or value, and/or other parameters. These parameters may be stored in the memory 119. The propulsion system 143 may also include one or more axles 164 including one or more differentials 166 of one or more axles 164 of the host vehicle 100. As an example, the brake control system 141 may be implemented as a brake-by-wire system, such as an electromechanical braking system or an electro-hydraulic braking system. The steering system 142 may be an electrical power steering system.

FIG. 2 shows a stationary power station 200 including an example fuel cell system 202. The fuel cell system 202 includes fuel sources 204, FCMs 206, a main control module 208, a load interface 210, a transceiver 212 and memory 214. The fuel sources 204 may be hydrogen and oxygen sources. The FCMs 206 may be configured as any of the FCMs referred to herein. The main control module 208 may request power from the FCMs 206 and/or may control operation of the FCMs 206. The load interface 210 may include low voltage and/or high voltage terminals for connecting to one or more loads 230. In FIG. 2, the fluid lines (or channels) are designated 220 and the electrical lines are designated 222. Although shown as a stationary power station with the loads being separate from the stationary power station 200, the stationary power station 200 may be implemented as a machine and include the loads, where the loads include actuators, motors, etc.

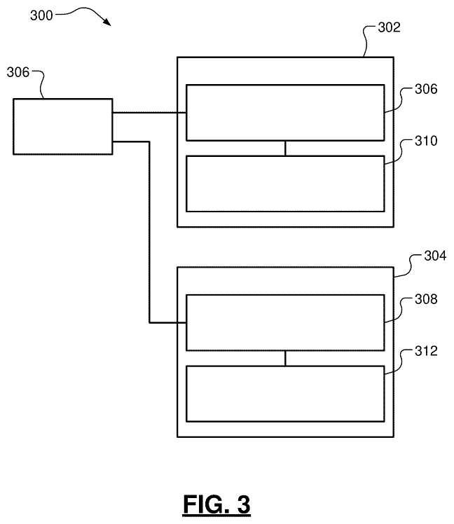

FIG. 3 shows a control system 300 for multiple fuel cell modules (FCMs) 302, 304, which may be in communication with and/or controlled by an application control module 306. Although two FCMs are shown, any number of FCMs may be connected to the application control module 306, which may refer to the vehicle control module 107 of FIG. 1, the main control module 208 of FIG. 2, or other application control module. Each of the FCMs 302, 304 includes respective electrical domain control (EDC) modules 306, 308 and fluidic domain control (FDC) modules 310, 312.

As an example, the control system 300 may be implemented in a truck application. The EDC modules 306, 308 may include control code and algorithms and are able to arbitrate multiple FCMs and communicate with a system communication gateway. The FDC modules 310, 312 may drive anodes and cathodes of fuel cell stacks. Data may be transmitted between the EDC modules 306, 308 and the FDC modules 310, 312. Data and stimulus signals may be transmitted between the application control module 306 and the EDC modules 306, 308. Control signals may be transmitted from the application control module 306 to the EDC modules 306, 308. Control signals may be transmitted from the EDC modules 306, 308 to the FDC modules 310, 312, which may or may not have originally be generated in the EDC modules 306, 308. In another embodiment, the application control module 306 may include FCM code and algorithms and arbitrate multiple FCMs. The EDC modules 306, 308 may be toggled to facilitate algorithm pass through features and/or include one or more hardware drivers.

FIG. 4 shows a signal and fluid flow diagram 400 of an example fuel cell system, such as any one of the fuel cell systems referred to herein. The diagram 400 includes fuel cell stack energy generation 402, stack sensing 404, power conversion 406, high voltage (HV) power distribution and sensing 408, and application load and energy storage 410. A fuel cell stack generates electrical energy, which is sensed by stack sensing 404. Power from the fuel cell stack is converted via power conversion 406 and resultant power is distributed and sensed by HV power distribution and sensing 408. Power may be provided to a direct current (DC)-to-alternating current (AC) converter 420, a DC-to-DC converter 422, and another DC-to-DC converter 424, which respectively power an air compressor 426, a HVC 428, and a hydrogen pump 430. There may be heat loss experienced during power conversion 406 and/or at the converters 420, 422, 424, as represented by 426. Balance of plant (BOP) 432 may be used to direct fluids including fuel, air and coolant to the fuel cell stack, as represented by arrow 440. In FIG. 4, fluid lines (or channels) are represented by dashed lines 442 and electrical lines are represented by solid lines 444. Controls data may be generated during stack sensing 404 and HV power distribution and sensing 408, as represented by 446 and may be used to control actuators, valves, pumps, etc.

Safety systems may be implemented during operations associated with 402, 404, 406, 408, and 410. This may include sensing voltages, current levels, temperatures, etc. and performing operations to prevent system and/or component degradation based on the sensed parameters. Low voltages (e.g., 0-350V) may be used and low voltage operations may be implemented during fuel cell stack energy generation 402, stack sensing 404, and power conversion 406. High voltages (e.g., 400-850V) may be used and high voltage operations may be implemented during power conversion 406 and HV power distribution and sensing 408. DC and/or AC power may be output to the one or more application loads via one or more voltage buses and/or power terminals. DC power may be provided to energy storage, which may include one or more battery packs.

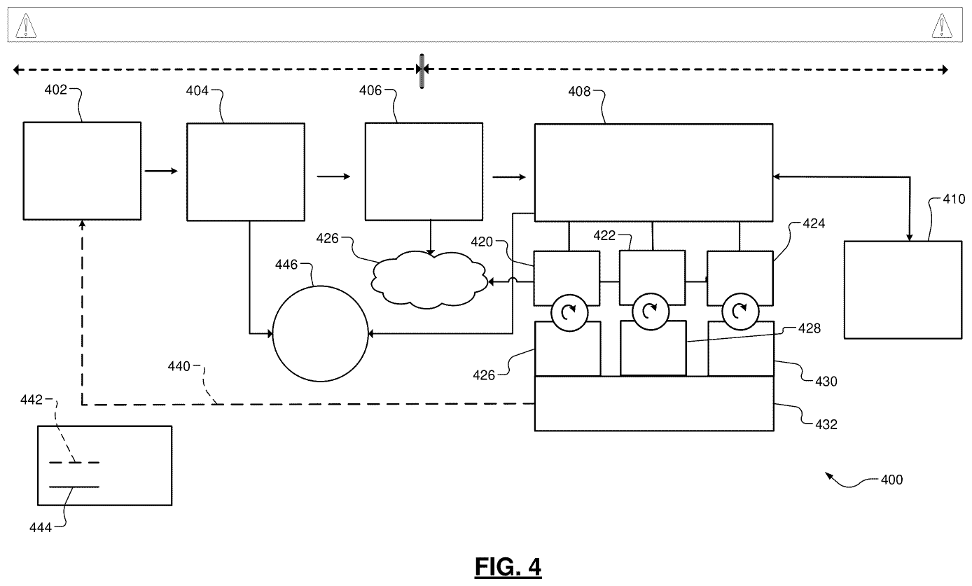

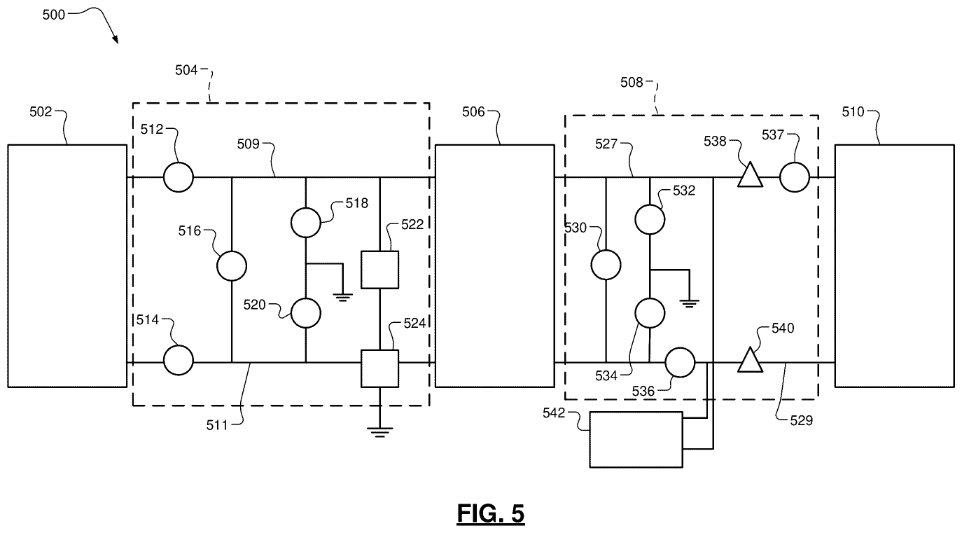

FIG. 5 shows a portion 500 of an example fuel cell system illustrating various different sensors. The portion 500 includes a fuel cell stack 502, a first sensing circuit 504, power electronics 506, a second sensing circuit 508, and application load and energy storage 510. The fuel cell stack may include a stack that is a collection of plates (e.g., stainless-steel plates, graphite plates, composite plates, etc.) and membranes through which air and hydrogen are passed to generate electrical energy, which is converted to usable voltages. The sensing circuits 504, 508 may be partially or fully implemented during stack sensing 404 and/or HV power distribution and sensing 408 of FIG. 4 and/or by one or more MPEMs, examples of which are shown in FIG. 6.

The first sensing circuit 504 may include a high voltage high-side rail 509, a high voltage low-side rail 511, current sensors 512, 514, voltage sensors 516, 518, 520, a pyrotechnic discharge device 522, and a switch 524. The current sensor 512 is connected to the fuel cell stack 502 and the power electronics 506 along the rail 509. The current sensor 514 is connected to the fuel cell stack 502 and to the power electronics 506 along rail 511. The voltage sensor 516 is connected across the rails 509, 511 and to the current sensors 512, 514. The voltage sensors 518, 520 are connected in series across the rails 509, 511, and the series of 518, 520 is connected in parallel with the voltage sensor 516. The pyrotechnic discharge device 522 is connected in series with the switch 524 and the connected series is connected across the rails 509, 511 and in parallel with the connected series of the voltage sensors 518, 520. The voltage sensors 518, 520 and the switch 524 are connected to ground. The switch 524 may be a perturbation switch for an isolation monitor.

The current sensor 512 may be a fuel cell stack primary DC current sensor. The current sensor 514 may be a fuel cell stack secondary DC current sensor. The voltage sensor 516 may be a fuel cell stack HV+ to HV− sensor. The voltage sensor 518 may be a fuel cell stack HV+ to chassis voltage sensor. The voltage sensor 520 may be a fuel cell stack chassis to HV− voltage sensor. The pyrotechnic discharge device 522 may be a fast fuel cell stack discharge device.

The second sensing circuit 508 may include a high voltage high-side rail 527, a low voltage low-side rail 529, voltage sensors 530, 532, 534, current sensors 536, 537, pyrotechnic disconnect device 538, and a pyrotechnic disconnect device 540. The voltage sensor 530 is connected across the rails 527, 529 and may be an application HV+ to HV− sensor. The voltage sensors 532, 534 are connected in series, across the rails 527, 529, and to ground. The voltage sensor 532 may be an application HV+ to chassis sensor. The voltage sensor 534 may be an application chassis to HV− sensor. The current sensor 536 is on the low-side rail 529 and may be a gross FCM DC current sensor. The current sensor 537 is connected along the high-side rail 527 and may be a net FCM DC current sensor. The pyrotechnic disconnect device 538 is connected along the high-side rail 527 and may be for a HV+ terminal. The pyrotechnic disconnect device 540 is connected along the low-side rail and may be for a HV− terminal.

FIG. 6 shows a FCM 600 having a modular and adaptable platform including a fuel cell stack 602 and MPEMs 604, 606, 608, a fuel and air circuit 610, a water vapor transfer device 612, an air machine (or air compressor) 614, a hydrogen pump 616, and a HVC pump 618. The MPEM 604 may be a power conversion module (PCM). The MPEM 606 may be a power distribution control and sensing module. The MPEM 608 may be a FDC module.

The MPEMs 604, 606, 608 may include sub-system modules. As an example, the MPEM 604 may include sub-system modules 620 and the MPEM 606 may include sub-system modules 622. The sub-system modules 620, 622 may be dedicated to performing various operations as further described below and may be easily accessed, serviced, connected up, enabled, replaced, and swapped out with a different sub-system module. Components of the sub-system modules 620, 622 may also be easily accessed, serviced, connected up, enabled, replaced, and swapped out with different components. The MPEMs 604, 606, 608 may also include one or more communication bus and terminals for communicating with the other ones of the MPEMs, modules within the other MPEMs, and/or other devices. The MPEMs 604, 606, 608 may also include low voltage and/or high voltage bus bars and terminals and cooling channels. As an example, the MPEM 604 is shown having power bus(es) 630, a communication bus 632, and cooling channels 634, which may extend across the MPEM 604 and couple to the MPEM 606 and/or the MPEM 608. In an embodiment, the MPEMs 604, 606, 608 have common external hardpoints to allow for rearranging the MPEMs 604, 606, 608 in different arrangements but have different internal hardware for performing different functional operations.

The sub-system modules 620, 622 may be dedicated to performing various operations as further described below and may be connected to the power buses 630, the communication bus 632, and/or the cooling channels 634. The power buses 630, the communication bus 632, and the cooling channels 634 may be connected to one or more of the exterior interfaces 636, 638 and/or one or more other exterior interfaces. The power buses 630 may be low voltage and/or high voltage DC and/or AC power buses. The exterior interfaces 636, 638 may be connected respectively to the exterior interfaces 640, 642 of the MPEMs 608, 606.

The MPEM 606 may include another exterior interface 646 that is connected to an exterior interface 648 of the fuel cell stack housing 650. The exterior interfaces 642, 646 may be connected to communication buses and/or voltage bus bars 652 and cooling channels 654 of the MPEM 606. The MPEM 606 may include another exterior interface 658 that is connected to an exterior interface 660 of the air machine (or air compressor) 614. The exterior interface 658 may be connected to the buses and bus bars 652, the cooling channels 654, and/or one of the sub-system modules 622. The modules 604 and 606 may have standardized cooling such that they have cooling ports that are the same shape and size and are used to circulate the same coolant (or cooling fluid).

The exterior interfaces 636, 638, 640, 642, 658, 660 may be configured similarly or the same. An example of which is shown in FIG. 11. The exterior interfaces 636, 638, 640, 642, 658, 660 are standardized to allow for modular arrangement of the MPEMs 604, 606, 608. Although the MPEMs 604, 606, 608 are shown having a certain number of exterior interfaces, each of the MPEMs 604, 606, 608 may have any number of exterior interfaces as described to allow for additional coupling arrangements. By having standardized (or common) exterior interfaces, the MPEMs are able to be moved and coupled in different arrangements.

The MPEM 606 may further include: a low voltage data and power output interface 670 for communication and powering low voltage loads; one or more access panels 672 to allow for access to, servicing of, and replacement of components of the MPEM 606 including changing of the sub-system modules 622 and/or components thereof; a high voltage output interface 674; a high voltage BOP interface 676 powering the HVC pump 618; and a high voltage BOP interface 678 powering the hydrogen pump 616. Although not shown in FIG. 6, each of the sub-system modules 622 may be connected directly or via an interior interface to the exterior interface 642, the exterior interface 646, the exterior interface 658, the low voltage data and power output interface 670, the high voltage output interface 674, the HV BOP interface 676, and the HV BOP interface 678. The MPEM 608 may further include a low voltage data and power output interface 680.

The air machine 614 may include a cooling circuit 690 and a compressor inverter module (CPIM) communication interface 692, which may be connected to the exterior interface 660.

FIG. 7 shows the modular power electronics module (MPEM) 606 of FIG. 6 (also referred to as a power distribution control and safety module). The MPEM 606 includes the sub-system modules 622, the exterior interfaces 642, 646, 658, the output interfaces 670, 674, the access panels 672, and the HV BOP interfaces 676, 678. The exterior interface may be a HV BOP interface. The HV BOP interface 658 may connect to the CPIM communication interface 673 and/or to cooling channels 675 via interface 660. The HV BOP interface 658 may include cooling and/or low voltage communication terminals. Each of the sub-system modules 622 includes corresponding functional and/or application modules. For example, a first one of the sub-system modules 622 is shown including an EDC module 710, a stack sensing module 712, a high frequency resistance (HFR) sensing module 714, a filtering module 716, a pyrotechnics module 718, and/or one or more other functional and/or application modules. The EDC module 710 may control operations of the MPEM 606. The MPEM 606 may receive power request signals and/or other command signals from a central control module such as the vehicle control module 107 of FIG. 1 or the main control module 208 of FIG. 2. The power request signals request certain amounts of power to be output from the corresponding fuel cell stack. The stack sensing module 712 monitors states of the fuel cell stack, such as voltages current levels, power output, and temperatures of the fuel cell stack.

The HFR sensing module 714 determines one or more HFRs of the fuel cell stack (or membranes thereof). The filtering module 716 filters power conversion elements in the PCM 604. The pyrotechnics module 718 may discharge current when certain conditions arise. For example, when a temperature of the fuel cell stack is above a set threshold, the pyrotechnics module 718 may be used to discharge fuel cell stack in case of stack overvoltage or a collision and to disconnect the fuel cell stack from the high voltage bus in case of a collision. To control fuel cell stack temperature, coolant flow is increased and if temp is still rising the controls will de-rate power when temperature gets to a certain threshold.

The EDC module 710 may implement the safety control processes referred to herein including safety and fault tolerance operations. The EDC module 710 may control high-voltage isolation and stack discharge hardware operations, pyrotechnic disconnect operations, and system sensing and isolation operations for fault detection and response. The EDC module 710 may communicate with, share parameters with, and/or control one or more of the modules 604, 608 of FIG. 6. The EDC module 710 may control operation of the corresponding fuel cell stack or a centralized control module (e.g., the vehicle control module 107 of FIG. 1 or the main control module 208 of FIG. 2) may control operation of the fuel cell stack by instructing the EDC module 710.

As another example, a second one of the sub-system modules 622 includes an application sensing module 720, a fuse module 722, and/or one or more other functional and/or application modules. The application sensing module 720 may include and monitor sensors specific to a particular application. The fuse module 722 may include fuses, which may be “blown” when certain conditions arise. As another example, a third one of the sub-system modules 622 includes contactors 724 and inverters 726.

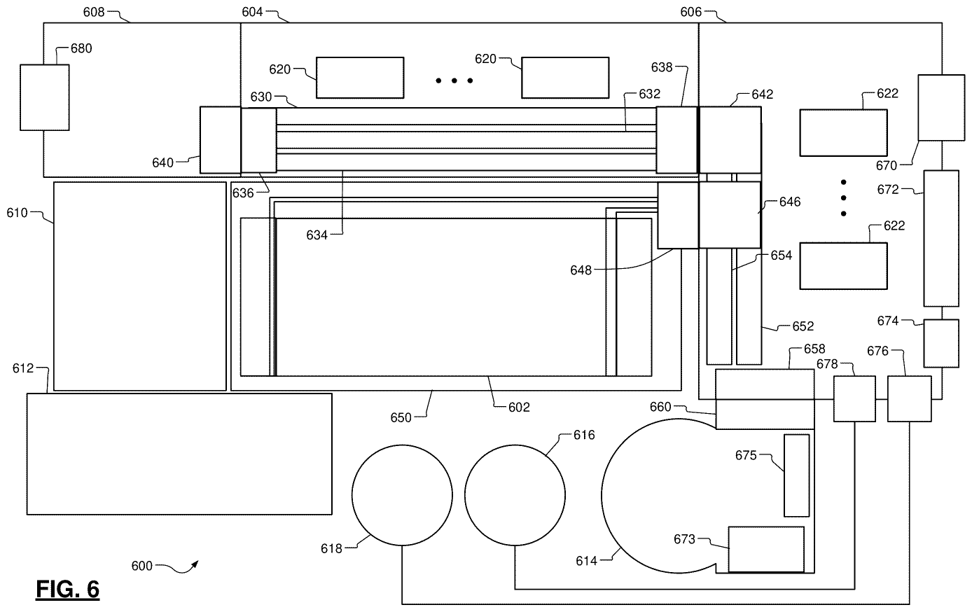

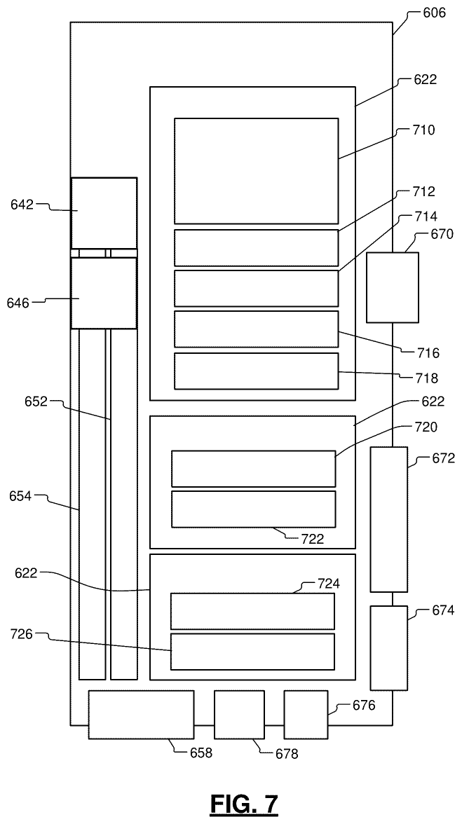

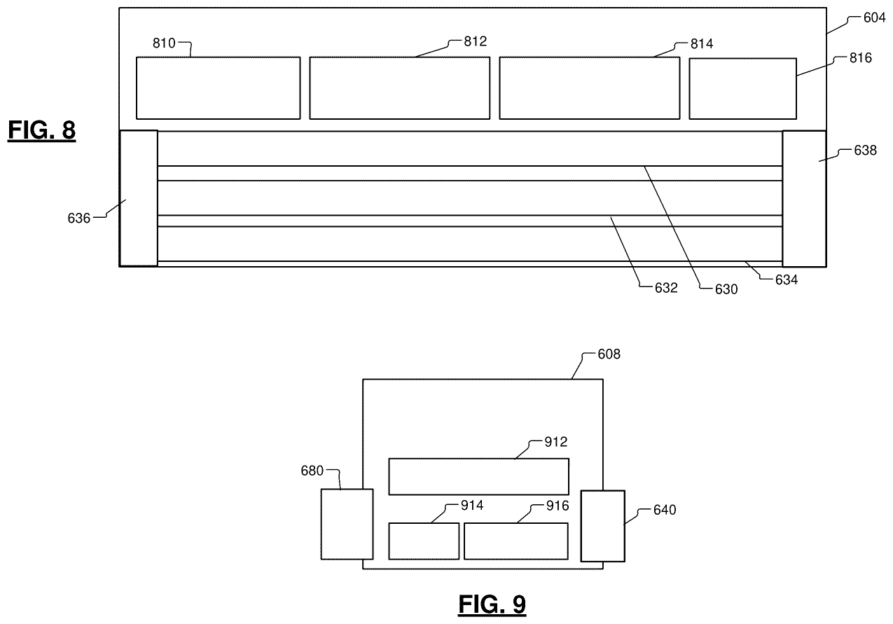

FIG. 8 shows the MPEM 604 of FIG. 6 (or power conversion module). The MPEM 604 may include sub-system modules 620, the power buses 630, the communication bus 632, the cooling channels 634, and the exterior interfaces 636, 638 of FIG. 6. As an example, the MPEM 604 may include a power conversion module 810, a sensing module 812, a HFR (perturbation) module 814, a filtering module 816, and/or other functional and/or application modules. The power conversion module 810 converts DC power from a corresponding fuel cell stack to DC and AC voltages to be output to one or more loads. The stack feeds power from bus bars 652 to power buses 630 and the power buses 630 distribute the power to one or more power conversion modules. The converted power is then returned to module 606 via an output side bus (not shown), which may be another power bus, which is located in each of the modules 604, 606 and may be connected to the exterior interfaces 638, 642. The output side bus is what is then used to distribute power from 606 to an application load external to the module 606 via, for example, the HV output 674. The exterior interfaces 538, 540 may be used to isolate the fuel cell module from the application load. The DC and AC voltages may be provided via the power buses 630 to bus bars 652 of FIG. 7, which may then provide the DC and AC voltages to the LV and HV output interfaces 670, 674. The sensing module 812 measures voltages, currents and temperatures of the fuel cell stack and/or of other terminals and/or components of the corresponding FCM. The sensors monitored by the sensing module 812 may be separate from the sensors monitored by the stack sensing module 712 of FIG. 7 and monitor voltages, current levels and/or temperatures of the same or different terminals and/or components of the FCM. The sensors monitored by the sensing module 812 and the stack sensing module 712 may be located on the fuel cell stack, external to and separate from the fuel cell stack, in the MPEMs 604, 606, or elsewhere. The modules 814, 816 may operate similarly as the modules 714, 716 of FIG. 7.

FIG. 9 shows the MPEM 608 of FIG. 6 (or fluidic domain control module). The MPEM 608 may include hardware drivers 912, fuses 914, a master LIN 916, and/or other functional and/or application modules. The MPEM 608 may control states of valves, pumps, actuators, air machine, etc. and monitor various sensors. In an embodiment, this control and monitoring is minimized and performed by the EDC module 710 of FIG. 7 or a centralized control module (e.g., the vehicle control module 107 of FIG. 1 or the main control module 208 of FIG. 2). The MPEM 608 may control the fuel and air circuit 610, the pumps 616, 618, and/or other devices of the FCM 600 of FIG. 6. The MPEM 608 may include the exterior interface 640 and the LV data and power interface 680.

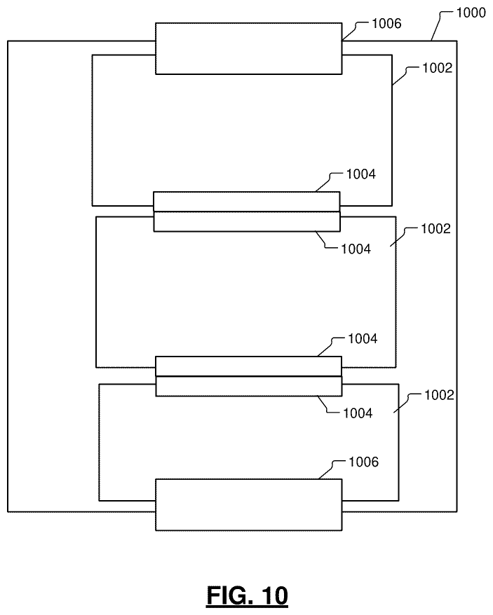

Although each of the sub-system modules of each of the MPEMs 604, 606, 608 of FIGS. 7-9 are shown having certain functional and/or application modules, each of the sub-system modules may include additional or other functional and/or application modules. Also, the functional and/or application modules shown as being implemented by the MPEM 604 may be implemented by the MPEM 606 and vice versa. The MPEMs 604, 606, 608 of FIGS. 7-9 are shown without interior interfaces and do not show exterior interfaces connected to the sub-system modules. The MPEMs 604, 606, 608 may include and/or be connected to the exterior interfaces and may include interior interfaces. Examples of these interfaces are shown in FIGS. 11-12. In an embodiment, the functional and/or application modules of each of the MPEMs 604, 606, 608 include the same types on interior interfaces and/or exterior interfaces to allow the functional and/or application modules to be arranged in different orders and connected up differently for different applications.

FIG. 10 shows a MPEM 1000, which may represent each of the MPEMs 604, 606, 608 of FIGS. 6-9, illustrating interior and exterior interfaces relative to sub-system modules. The MPEM 1000 includes sub-system modules 1002 that include interior interfaces 1004 and exterior interfaces 1006. The exterior interfaces may represent and/or be configured similarly as the exterior interfaces 636, 638, 640, 642, 646, 658 of FIG. 6. The sub-system modules 1002 may include any of the functional and/or application modules referred to herein.

FIG. 11 shows an exterior interface 1100 that may represent any of the exterior interfaces of FIGS. 6-10. The exterior interface 1100 may include: a communication connector 1102 with communication signal terminals 1103 (e.g., current or voltage signals) and power terminals 1104; hot and cold cooling channels 1105; and positive and negative high-voltage bus bars 1106 and corresponding terminals.

FIG. 12 shows an example interior interface 1200 that may represent any of the interior interfaces of FIG. 10. The interior interface 1200 may include: a communication connector 1202 with communication signal terminals 1203 (e.g., current or voltage signals) and power terminals 1204; and positive and negative high-voltage bus bars 1206 and corresponding terminals.

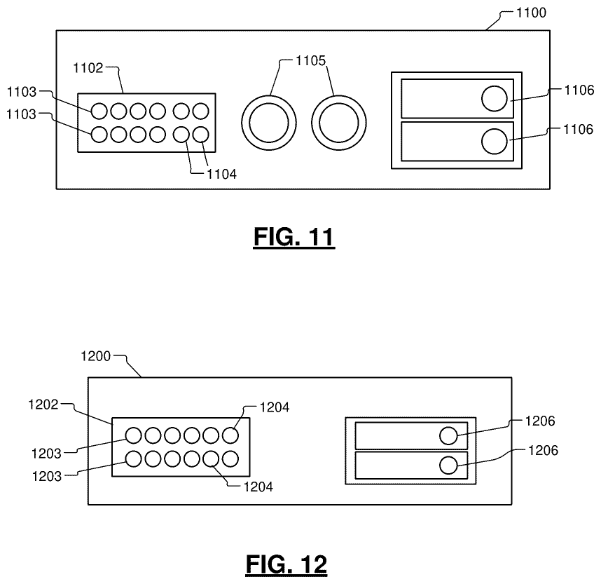

The sub-system modules referred to above may be configured similarly as any of the sub-system modules of FIGS. 13-18, where the interior interfaces may include any of the below mentioned connectors, terminals, and/or bus bars.

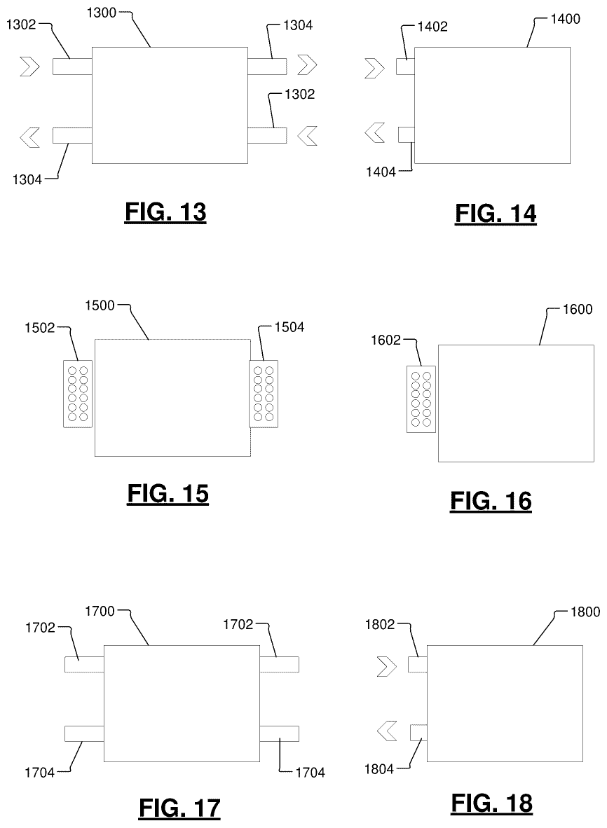

FIG. 13 shows a sub-system module 1300 with a passthrough cooling circuit including input channels 1302 and output channels 1304 providing internal and/or passthrough cooling. FIG. 14 shows an example sub-system module 1400 with non-passthrough cooling circuit including an input channel 1402 and an output channel 1404. FIG. 15 shows an example sub-system module 1500 with a low voltage electrical passthrough circuit including an input connector 1502 and an output connector 1504. The terminals of the input connector 1502 may be connected to components within the sub-system module 1500 and to the terminals of the output connector 1504. The terminals of the connectors 1502, 1504 may include communication and power terminals.

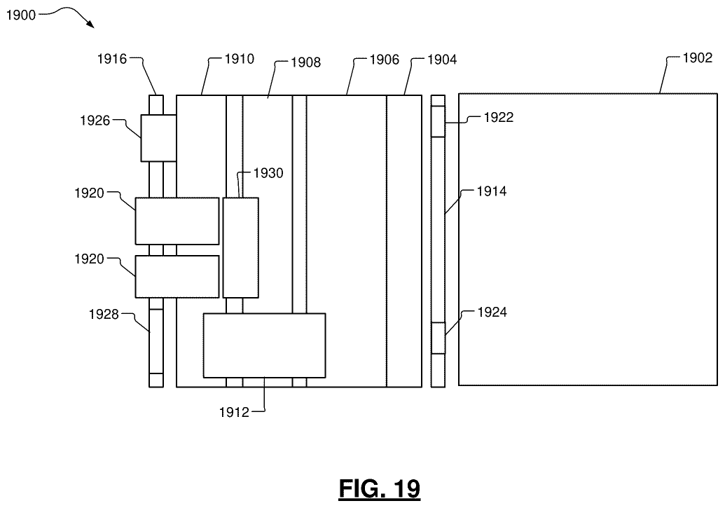

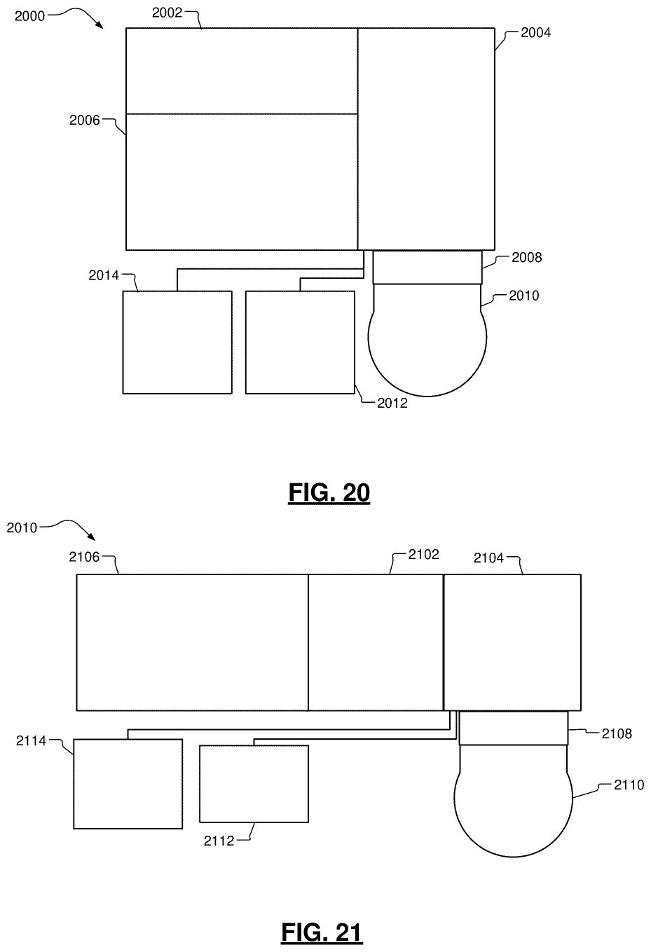

FIG. 16 shows an example sub-system module 1600 with a low voltage electrical non-passthrough circuit including a connector 1602, which may include input and/or output terminals including communication terminals and power terminals. FIG. 17 shows an example sub-system module 1700 with a high voltage electrical passthrough circuit including terminals 1702 that may be connected to a first one or more bus bars and terminals 1704, which may be connected to a second one or more bus bars. FIG. 18 shows an example sub-system module 1800 with a high voltage electrical non-passthrough circuit, which may include one or more input terminals 1802 and one or more output terminals 1804.

FIG. 19 shows a layered representation 1900 of the FCM 600 of FIG. 6. The MPEMs of a FCM may be implemented as layers stacked on a fuel cell stack 1902. The layers may be implemented in one or more side boxes that are physically connected to a box (or housing) of the fuel cell stack 1902. As an example, each layer may have four side walls and open ends. The side walls of each layer are then stacked and components of the layers are coupled together. The resulting one or more stacks of layers are attached to the box of the fuel cell stack 1902. Multiple example layers are shown and may include a cooling layer 1904, a stack HV layer 1906, a control board layer with sub-structure housing 1908, and an application voltage layer 1910. A safety and service layer 1912 may be coupled to the layers 1906, 1908, and 1910. The layers 1904, 1906, 1908 and 1910 may be disposed between a FCM boundary stack side 1914 and a FCM boundary 1916. Integrated HV modules 1920 for a HVC pump and a hydrogen pump may be connected to the application voltage layer 1910 and the FCM boundary 1916. The FCM boundary stack side 1914 may include connection points 1922, 1924. The FCM boundary 1916 may include HV connection points 1926 and an access panel 1928. A cooling layer 1930 may be connected to the layers 1908, 1910.

Although the layers 1904, 1906, 1908, 1910, 1912, 1930 are shown in a particular arrangement and stacked in a particular order, the layers 1904, 1906, 1908, 1910, 1912, 1930 may be arranged differently and/or stacked in a different order. In an embodiment, the layers 1904, 1906, 1908, 1910, 1912, 1930 have standardized interfaces, such as the exterior and interior interfaces referred to herein to enable the layers to be connected up in different arrangements.

FIG. 20 shows a functional block diagram of a portion 2000 of a FCM in a first (or centralized) arrangement. The portion 2000 includes a power conversion module (PCM) 2002, a power distribution control and sensing module (PDCSM) 2004, a fuel cell stack 2006, a compressor inverter module 2008, an air compressor 2010, a HVC pump 2012, and a hydrogen pump 2014. In this example, the PCM 2002 and the PDCSM 2004 are coupled to the fuel cell stack 2006 and to each other via exterior interfaces (not shown in FIG. 20 but may be configured similarly as any of the exterior interfaces disclosed herein).

FIG. 21 shows a functional block diagram of a portion 2100 of a FCM in a second (or stacked) arrangement. The portion 2100 includes a PCM 2102, a PDCSM 2104, a fuel cell stack 2106, a compressor inverter module 2108, an air compressor 2110, a HVC pump 2112, and a hydrogen pump 2114. In this example, the PCM 2102 is coupled to the fuel cell stack 2106 and between the fuel cell stack 2106 and the PDCSM 2104. The PCM 2102 may be coupled to the fuel cell stack 2106 and to the PDCSM 2104 via exterior interfaces (not shown in FIG. 21 but may be configured similarly as any of the exterior interfaces disclosed herein). In another embodiment, the PDCSM 2104 is coupled between the fuel cell stack 2106 and the PCM 2102.

FIG. 22 shows a portion 2200 of a FCM in a third (or centralized) arrangement. The portion 2200 includes a fuel cell stack 2202, a PCM 2204, and a PDCSM 2206. The PCM 2204 is coupled on top of the fuel cell stack 2202 and the PDCSM 2206. This may be accomplished via exterior interfaces disclosed herein. The PDCSM 2206 may include, for example, “punch outs” 2210, which may be removed when additional sub-system modules are added to the PDCSM 2206.

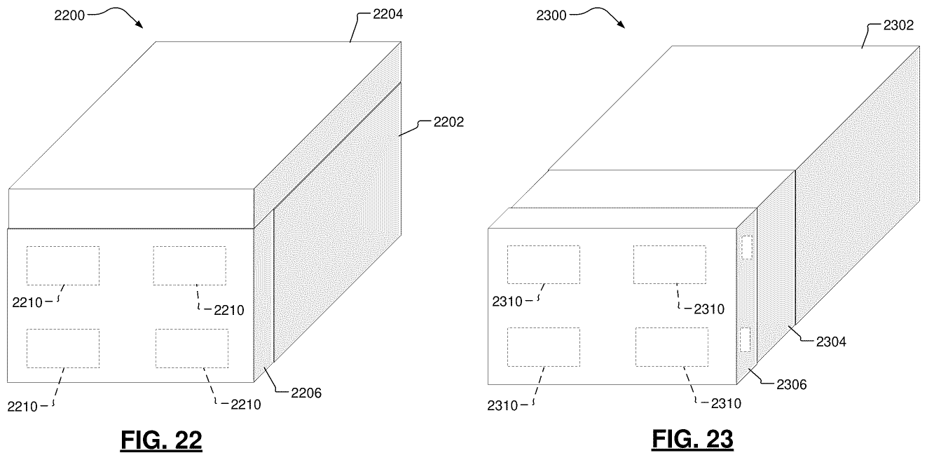

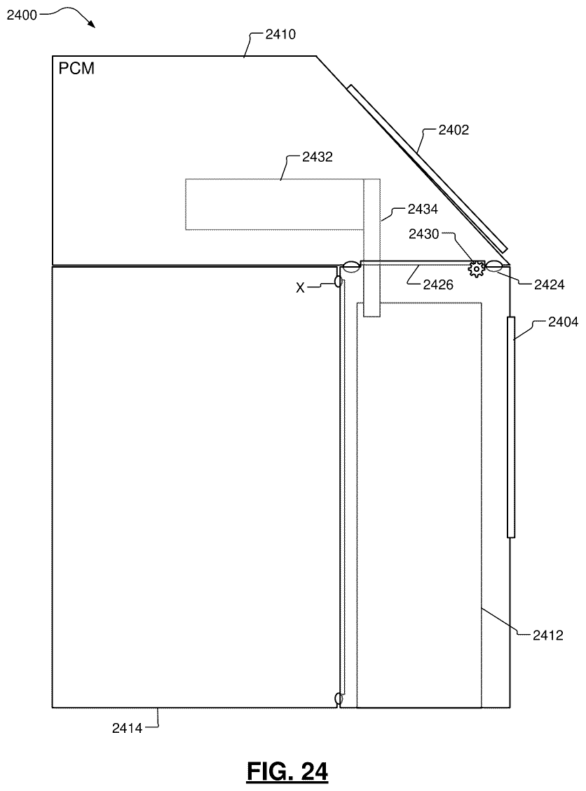

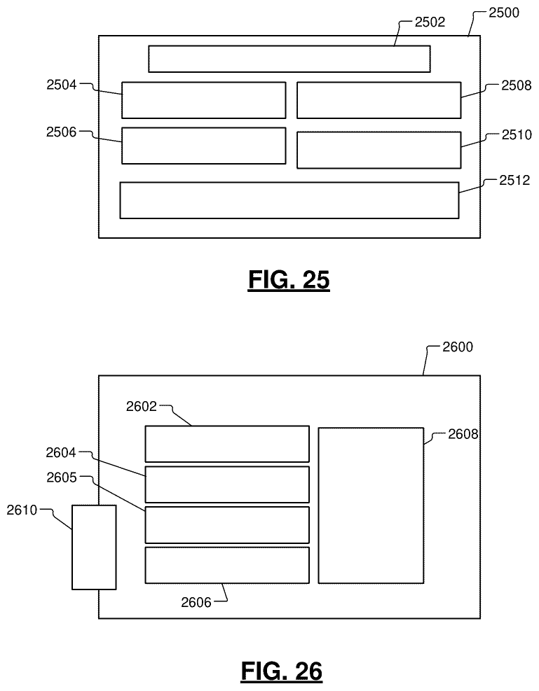

FIG. 23 shows a portion 2300 of a FCM in a fourth (or stacked) arrangement. The portion 2300 includes a fuel cell stack 2302, a PCM 2304, and a PDCSM 2306. The PDCSM 2306 is coupled between the PCM 2304 and the fuel cell stack 2302 and is coupled to the PCM 2304 and the fuel cell stack 2302 via exterior interfaces as disclosed herein. The PDCSM 2306 may include, for example, punch outs 2310, which may be removed when additional sub-system modules are added to the PDCSM 2306.

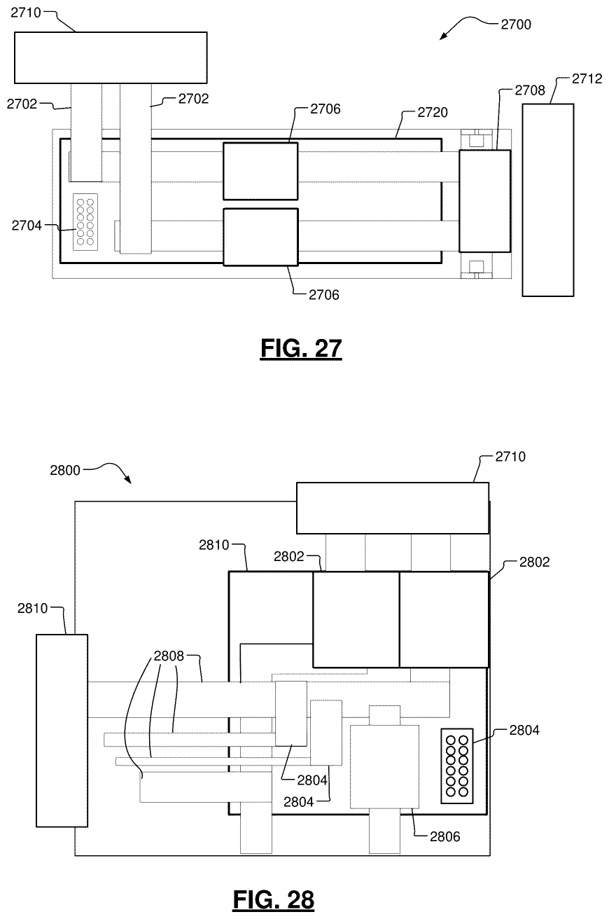

FIG. 24 shows a portion 2400 of a FCM having an arrangement similar to that of FIG. 22 with access panels 2402, 2404. The portion 2400 includes a PCM 2410, a PDCSM 2412, and a fuel cell stack 2414. The access panels 2402, 2404 provide maintenance, service and tooling windows to access, service, and replace components and modules of the PCM 2410 and the PDCSM 2412. This allows for easy modification, replacement and reconfiguring of sub-system modules of the PCM 2410 and the PDCSM 2412. An O-ring 2424 may be disposed between the PCM 2410 and the PDCSM 2412 and surround an opening 2426 and/or exterior interfaces of the PCM 2410 and the PDCSM 2412. A torturous path for liquids 2430 may be included in the PDCSM 2412 and between the PCM 2410 and the PDCSM 2412. A couple of bus bars 2432, 2434 are shown and are connected to sub-system modules of the PCM 2410 and the PDCSM 2412.

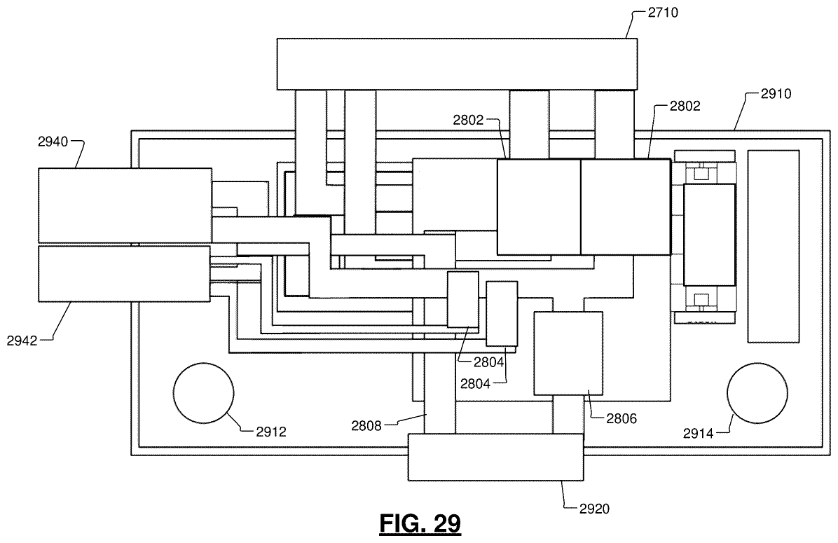

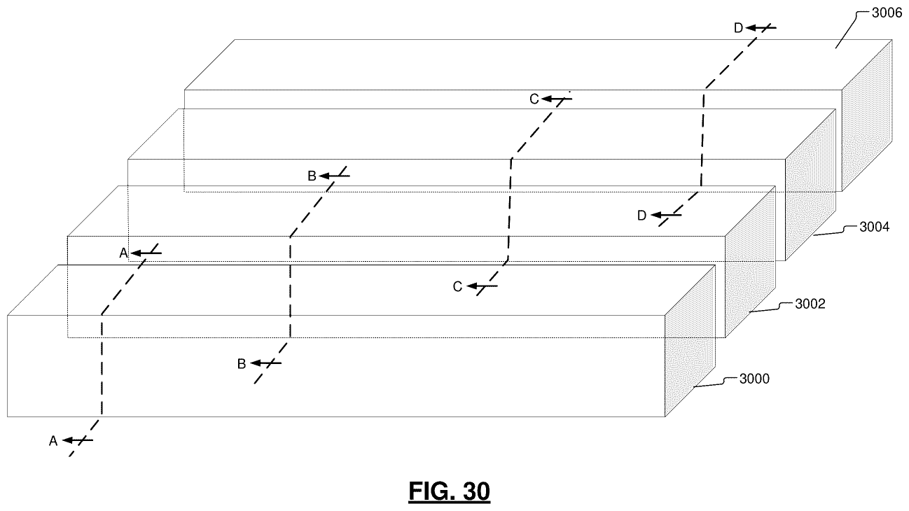

FIGS. 25-26 show example sub-system modules with distributed functions. FIG. 25 shows an example sub-system module 2500 that includes bus bars 2502, a stack sensing module 2504, a HFR sensing module 2506, pyrotechnics module 2508, filtering module 2510, and an EDC control module 2512. The bus bars 2502 and modules 2504, 2506, 2508, 2510, 2512 may be configured and function similarly as other similarly named bus bars and modules referred to herein.

FIG. 26 shows another example sub-system module 2600 that includes a filtering module 2602, an application sensing module 2604, a fuse module 2605, a pyrotechnics module 2606, bus bars 2608, and a HV data and power output interface 2610. The modules 2602, 2604, 2605, 2606 and bus bars 2608 may be configured and function similarly as other similarly named bus bars and modules referred to herein.

FIG. 27 shows an example sub-system module (or layer) 2700 that may be an example of the sub-system module 2500 of FIG. 25 and is configured to perform fuel cell stack sensing, bus bar cooling, and filtering. The layer 2700 includes bus bars 2702, a connector 2704, sensing, cooling and filtering components (shown as current sensors 2706), a shorting device (e.g. a pyrotechnic device 2708), an interface 2710 and an interior interface 2712. The interface 2710 may be an exterior interface or an interior interface. The bus bars, 2702, the connector 2704, and the sensing, cooling and filtering components 2706 may be mounted on a substrate 2720. The shorting device 2708 and the interfaces 2710, 2712 may be mounted on the substrate 2720 or may be separate from the substrate 2720. The connector 2704 may be an exterior interface.

FIG. 28 shows a sub-system module (or layer) 2800 may be an example of the sub-system module 2600 of FIG. 26. The sub-system module 2800 may include pyrotechnic devices 2802 and fuses 2804, 2806 that are coupled to bus bars 2808 and mounted on a substrate 2810, which may include sensors (not shown in FIG. 28). The sub-system module 2800 may include: the interface 2710 of FIG. 27 and another interior interface 2810 that may be connected to the bus bars 2808 and to the pyrotechnic devices 2802; and a connector 2804, which may be an exterior interface.

FIG. 29 shows the sub-system module 2800 of FIG. 28 stacked on the sub-system module 2700 of FIG. 27. The subsystem modules 2700, 2800 may be mounted in and/or to a non-repeating hardware housing 2910, which may be connected to a fuel cell stack. The non-repeating hardware housing 2910 includes non-repeating hardware. This may include hardware of the fuel cell stack for which there are not multiples. The non-repeating hardware housing 2910 and/or a corresponding cooling layer may include hot and cold cooling channels 2912, 2914. Fuse 2806 and bus bar 2808 are connected to a CPIM interface 2920. Some of the bus bars are connected to a HV main connector 2940 and others may be connected to a HVC pump and hydrogen pump connector 2942.

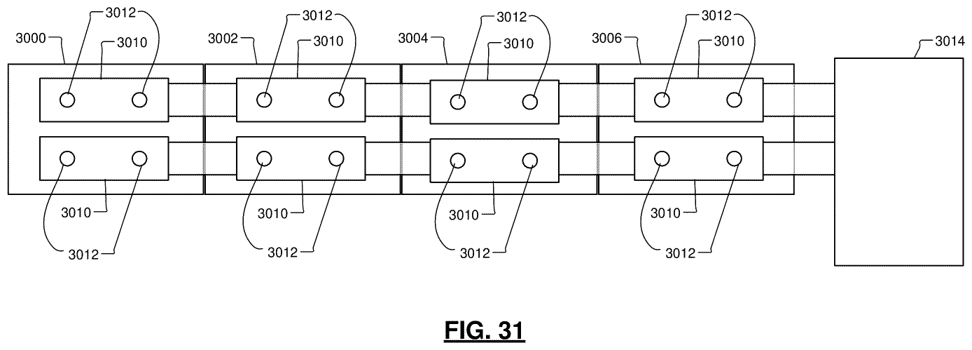

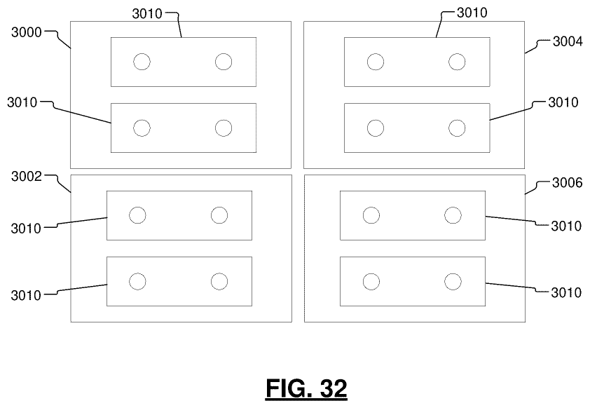

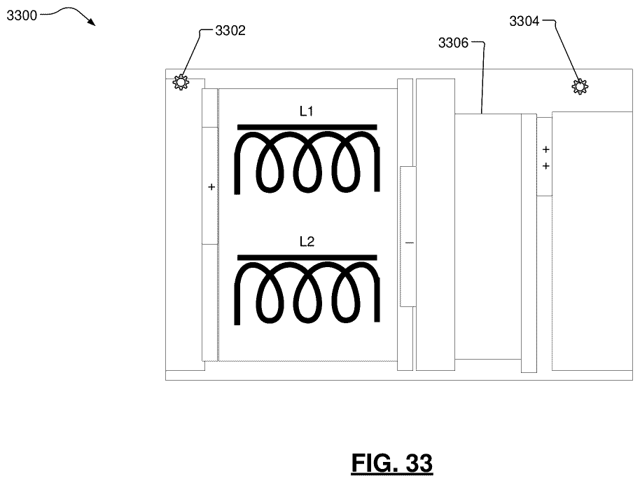

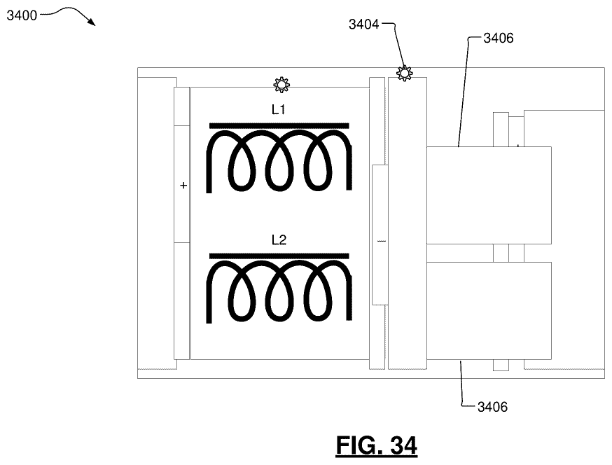

FIG. 30 is a perspective representative view of power bricks 3000, 3002, 3004, 3006 of a PCM. The power bricks 3000, 3002, 3004, 3006 may each have respective HV+ and HV− bus bars 3010, which may be connected in parallel, as shown in FIG. 31. As an example, each of the power bricks 3000, 3002, 3004, 3006 may output 50 kilowatts of power. FIG. 31 shows HV terminals 3012 of the HV+ and HV− bus bars 3010 and parallel connections of the power bricks 3000, 3002, 3004, 3006 in a first arrangement. FIG. 32 shows an end view illustrating the bus bars 2010 and HV terminals of the power bricks 3000, 3002, 3004, 3006 in a second arrangement. The bus bars 3010 may be connected to a PDCSM 3014.

Each of the power bricks 3000, 3002, 3004, 3006 may be configured the same. The following items shown with respect to FIGS. 33-36 may be included in each of the power bricks 3000, 3002, 3004, 3006. FIG. 33 shows a cross-sectional view 3300 through the power brick 3000 of FIG. 30 taken at section plane A-A. The cross-sectional view 3300 includes a side cooling channel 3302, inductors L1, L2, a heat plate 3304, and a power module 3306. The heat plate 3304 engages with next module in the power brick 3000 for shared cooling.

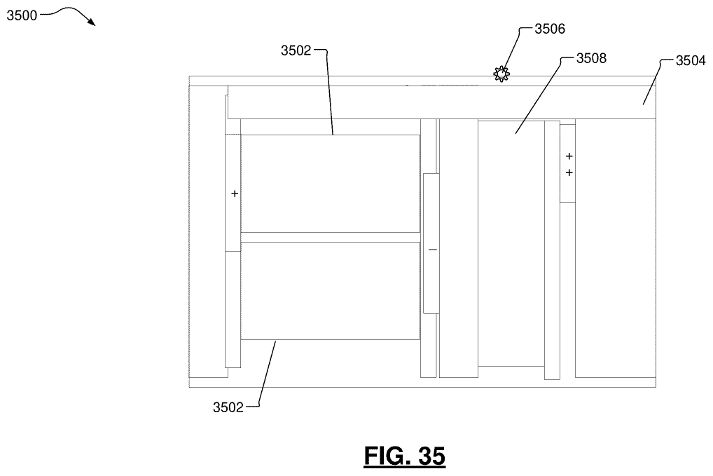

FIG. 34 shows a cross-sectional view 3400 through the power brick 3002 of FIG. 30 taken at section plane B-B. The power brick 3002 includes inductors L1, L2, a center cooling channel 3402, and capacitors 3406. The power brick 3002 may contain multiple sets of coupled power inductors or individual inductors based on the design of the power conversion characteristics. In an embodiment, the power brick 3002 operates in multiples of 3 power phases to allow for hardware conversion between a DC-DC converter and DC-DC inverter.

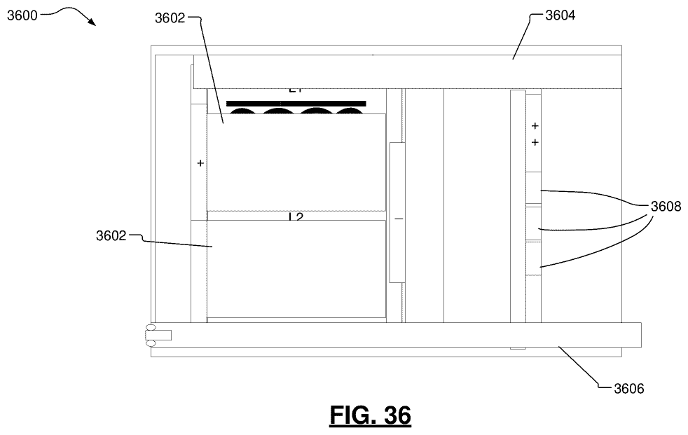

FIG. 35 shows a cross-sectional view 3500 through the power brick 3004 of FIG. 30 taken at section plane C-C. The power brick 3004 includes capacitors 3502, a control board 3504, an electromagnetic interference shielding 3506 on a plastic housing, and a power module 3508.

FIG. 36 shows a cross-sectional view 3600 through the power brick 3006 of FIG. 30 taken at section plane D-D. The power brick 3006 includes capacitors 3602, a control board 3604, coolant pipes 3606, and three phase output terminals 3608 for a 3-phase system for DC-AC but could be a two-terminal output for DC-DC.

The above-described examples include a modular fuel cell electrical architecture implementing fuel cell stack sensing, safety systems, power conversion, power distribution, and control hardware intended to manage balance of plant operations. The examples include a stack sensing module that is interchangeable and designed to meet core control data needs of the corresponding fuel cell system and sub-systems. The stack sensing module may be integrated in the non-repeating hardware of the corresponding fuel cell stack and can be built with varying levels of sensing robustness based on application requirements.

The examples further include a modular safety system with system isolation sensing, stack discharge mechanisms, high voltage disconnects, and pyrotechnic or solid-state disconnects. This ensures system safety during unsafe conditions on an electrical bus. In an embodiment, the modular safety system is designed to operate independently from control architecture if needed.

The examples include power conversion modules that are modular and support both isolated and non-isolated DC/DC and DC/AC converters for power conditioning and distribution. The power conversion modules provide flexible power export to energy storage, the grid, and direct DC loads.

The examples include a power distribution system including high-voltage bus bars, fuses, and connectors, which are designed to deliver power efficiently and safely from a fuel cell stack to application loads. The power distribution system is able to be reconfigured with minimal impact to major tooling and process.

The examples include a configurable EDC module capable of serving as a primary controller, a domain controller, and a data aggregator, depending on the application requirements. The EDC module supports multiple communication protocols (e.g., CAN, Ethernet, etc.) and integrates with fluidic and electrical sub-systems.

The above-described examples provide scalability and flexibility. The disclosed modular architecture allows for customization based on application needs. For example, different power converters (DC/DC, DC/AC) and safety components are integrated into the architecture without requiring changes to a power converter or a design of a fuel cell stack. This flexibility is particularly useful in systems where evolving requirements need to be met.

The examples further provide ease of integration. The disclosed modular architecture supports multi-channel communication protocols, which ensures that the fuel cell system can be easily integrated into a wide variety of applications including automotive, industrial, and energy sectors applications.

The examples further provide improved safety and fault tolerance. The fuel cell system includes built-in high-voltage isolation and stack discharge hardware to ensure safe operation. Modular safety features including pyrotechnic disconnects and system isolation sensing provide robust fault detection and response. This improves overall system reliability though the decoupled nature of the hardware.

The examples further provide adaptable sensing and monitoring. The stack sensing components are able to be configured to meet a wide range of robustness requirements, which ensures that critical control data is captured while also offering flexibility for different use cases. The examples further provide power conversion flexibility. The fuel cell system supports both non-isolated and isolated power converters, enabling flexible power conditioning for applications such as grid export, energy storage, and direct DC usage.

The examples further a single platform that accommodates different electrical components and configurations, providing a more efficient development process and faster deployment for fuel cell applications. The examples include versatile controls. One or more of the disclosed control modules are designed to be multi-functional and capable of controlling fluidics as well as managing electrical subsystems. This makes the control modules adaptable to various system architectures.

The examples further implement robust safety protocols. The integration of pyrotechnic disconnects and active/passive discharge hardware enhances safety and prevents potential failures, which provides a fail-safe system for high-power applications. The examples further provide supply chain robustness. An electrical system functional partition enables robust fuel cell power electronics supply chain development, which reduces commercialization cost in the long run.

The examples minimize the number and sizes of components while providing modularity of components and modules for increased flexibility in design and layout. The examples eliminate number and lengths of exterior cables, conduits, and other components.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A fuel cell module comprising:
a fuel cell stack comprising a first one or more exterior interfaces; and
a plurality of modular power electronics modules (MPEMs), wherein each of the plurality of MPEMs comprises
at least one sub-system module configured to perform operations with respect to the fuel cell stack; and
a respective one or more exterior interfaces each of which standardized and configured to couple to each of the first one or more exterior interfaces, wherein the one or more exterior interfaces of one of the plurality of MPEMs is configured to couple to the other exterior interfaces of the other ones of the plurality of MPEMs.

2. The fuel cell module of claim 1, wherein each of the first one or more exterior interfaces and the one or more exterior interfaces of the plurality of MPEMs comprises communication bus terminals and power terminals.

3. The fuel cell module of claim 2, wherein each of the first one or more exterior interfaces and the one or more exterior interfaces of the plurality of MPEMs comprises cooling channels.

4. The fuel cell module of claim 2, wherein the power terminals include low voltage terminals having voltages less than or equal to 48V and high voltage terminals having voltages greater than or equal to 50V.

5. The fuel cell module of claim 1, wherein:
each of the plurality of MPEMs comprises a plurality of sub-system modules including the at least one sub-system module of the corresponding one of the plurality of MPEMs; and
each of the plurality of sub-system modules comprises at least one interior interface standardized to couple to each other one of the interior interfaces of the plurality of sub-system modules of the corresponding one of the plurality of MPEMs.

6. The fuel cell module of claim 5, wherein the plurality of MPEMs comprise:
a first MPEM includes or is implemented as a power conversion module (PCM); and
a second MPEM implemented as a power distribution control and safety module (PDCSM).

7. The fuel cell module of claim 6, wherein the first MPEM comprises at least one of a power conversion module, a sensing module, a high frequency resistance sensing module, and a filtering module.

8. The fuel cell module of claim 6, wherein the PDCSM comprises at least one of a stack sensing module, a high frequency resistance sensing module, a filtering module, an application sensing module, a fuse module, a pyrotechnic module, a contactor module; and an inverter module.

9. The fuel cell module of claim 6, wherein the PDCSM comprises an electrical domain control module for controlling operation of the plurality of sub-system modules of the PDCSM and the fuel cell stack.

10. The fuel cell module of claim 9, wherein the electrical domain control module controls operation of at least one of the PCM and a fluidic domain control module.

11. The fuel cell module of claim 5, wherein at least one of the plurality of MPEMs comprises a plurality of bus bars including communication buses and power bus bars that extend between exterior interfaces of the at least one of the plurality of MPEMs.

12. The fuel cell module of claim 5, wherein one of the plurality of MPEMs is implemented as a fluidic domain control module and comprises hardware drivers, fuses, and a master local interconnect network.

13. The fuel cell module of claim 1, wherein the one or more exterior interfaces of one of the plurality of MPEMs couples to an electric air compressor of the fuel cell module that is driven by an inverter.

14. The fuel cell module of claim 13, wherein the one of the plurality of MPEMs comprises:
high voltage balance of plant interfaces configured to connect to a plurality of pumps;
one or more access panels for accessing the at least one sub-system module of the one of the plurality of MPEMs;
a low voltage data and power output interface configured to couple to a load; and
a high voltage output interface configured to couple to the load.

15. The fuel cell module of claim 1, wherein the plurality of MPEMs are configured to be coupled to each other and the fuel cell stack in a plurality of different arrangements.

16. The fuel cell module of claim 15, wherein the plurality of different arrangements comprise:
a stacked arrangement where a first MPEM is coupled between a second MPEM and the fuel cell stack, wherein the plurality of MPEMs comprise the first MPEM and the second MPEM;
a centralized arrangement where the first MPEM and the second MPEM are both coupled to the fuel cell stack; and
a combination arrangement where two or more of the plurality of MPEMs are coupled to the fuel cell stack and one or more other ones of the plurality of MPEMs are not coupled to the fuel cell stack but rather are coupled to one of the plurality of MPEMs.

17. The fuel cell module of claim 1, wherein:
the plurality of MPEMs are integrated with non-repeating hardware of the fuel cell stack;
the non-repeating hardware comprises at least one of: one or more housings; fuel cell ends; and
compression hardware.

18. A vehicle comprising:
one or more of the fuel cell module of claim 1 configured to generate electrical energy and comprising an electrical domain control module; and
a vehicle control module configured to communicate with the electrical domain control module to control operation of the fuel cell stack and control distribution of the electrical energy to devices of the vehicle.

19. A stationary power station comprising:
one or more of the fuel cell module of claim 1 configured to generate electrical energy and comprising an electrical domain control module; and
a main control module configured to communicate with the electrical domain control module to control operation of the fuel cell stack and control distribution of the electrical energy to loads connected to the stationary power station.

20. A fuel cell module comprising:
a fuel cell stack comprising a first one or more exterior interfaces; and
a plurality of modular power electronics modules (MPEMs), wherein each of the plurality of MPEMs comprises
at least one sub-system module configured to perform operations with respect to the fuel cell stack; and
a respective one or more exterior interfaces each of which standardized and configured to couple to each of the first one or more exterior interfaces, wherein the one or more exterior interfaces of one of the plurality of MPEMs is configured to couple to the other exterior interfaces of the other ones of the plurality of MPEMs,
wherein the plurality of MPEMs comprise
a first MPEM comprising a power conversion module and a filtering module, and
a second MPEM comprising a stack sensing module, a high frequency resistance sensing module, a filtering module, an application sensing module, a fuse module, and a pyrotechnic module.
